(19) United States
(12) Patent Application Publication
(10) Pub. No.: US 2006/0133103 A1
(43) Pub. Date: Jun. 22, 2006

(54) Sequential taillight illumination system

(76) Inventors: Michael D. Muhlbaier, Blackwood, NJ (US); Sebastian J. Blicharz, Blackwood, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 11/021,585

(22) Filed: Dec. 22, 2004

(51) Int. Cl. F21S 8/10

(52) U.S. Cl. 362/545

(57) ABSTRACT

A motor vehicle taillight employs light emitting diode (LED) technology, versus traditional incandescent lighting, to the sequential illumination of LED arrays, based on the nominal time it takes for LEDs to turn on and off. Separate or combined input signals from the brake, the turn signal blinker, and the rear marker activate controller subsystems to sequentially illuminate and deactivate LED arrays located within separate sections of the taillight. Significant benefits, such as lower power, cool burning, and long lasting bulbs result. In addition, the sequential LED array illumination design adds an intriguing effect, creating a marketable, visual appeal.

### BACKGROUND OF THE INVENTION

Over the last decade the automotive market has shown increasing interest in different and/or custom products for the enhancement of their vehicles. Lighting modifications, especially those concerning vehicle taillights, comprise a significant portion of this customization movement. One of the most popular items is the “Euro” style taillight which consists of individual red lenses surrounded by a chrome inner housing and encased by a smooth clear lens. This combination produces a distinct look that is exceptionally popular among street racers and show car owners.

These taillights typically employ incandescent light bulbs, but many enthusiasts exchange the bulbs with light emitting diodes (LEDs) for added customization and visual appeal. Since LEDs are much smaller and have lower power requirements than standard incandescent bulbs, they are often implemented in pre-formed arrays that simply plug into the existing outlet. In addition, LEDs rely on the properties of the diodes PN junction, compared to incandescent bulbs, which rely on the burning of a filament to provide illumination. This translates to a lower operating temperature, lower power consumption, and a lifetime twenty times longer than incandescent bulbs. LEDs also react on the average of six orders of magnitude faster. For tail/stoplight applications, this provides following vehicles additional time to react to the signal. At 60 mph, this extra time adds twenty feet of stopping distance.

Because of these characteristics, many automobile manufacturers are currently implementing LEDs into their taillight systems. The nature of the LED arrays allows the formation of distributed patterns that complement the vehicle's design. The result is a visually appealing display that is much safer and longer-lasting than any previous incandescent system. However, the primary LED technology currently available to the aftermarket are preformed, bulb-like arrays. For example U.S. Pat. No. 5,241,457 places LEDs into a third brake light. U.S. Pat. No. 6,499,870 uses LEDs and incandescent lights along with special reflectors to create different reflection angles. U.S. Pat. No. 6,550,949 uses LEDs to increase safety by creating bright lighting outside of the vehicle. It also employs the use of a camera for a vehicle imaging system. U.S. Pat. No. 5,896,084 shows that an LED controller can produce a very reliable LED taillight assembly. U.S. Pat. No. 6,357,902 offers a solution to having to deal with converting a current incandescent plug into an LED acceptable plug.

### SUMMARY OF THE INVENTION

Although recent taillight designs have incorporated the use of LED technology, the subject invention is novel as it is the first to employ this technology to the sequential illumination of LED arrays, based on the nominal time it takes for LEDs to turn on and off.

Since an LED will illuminate almost instantaneously (several nanoseconds), the sequential illumination of LED arrays provides an alternative to incandescent lighting. The first array will again light almost instantly resulting in a safer taillight. The sequential illumination of each consecutive array will occur in less time than an incandescent bulb will take to reach full brightness.

The subject system has several driver-controlled inputs based on the model of automobile. These inputs could include the brake signal, the turn signal blinker, the reverse signal, and the reverse or rear markers. Each of the signals activates a separate subsystem which controls LED arrays. The functionality of the reverse light is left unaltered.

More specifically, the brake signal is off until the brake is activated by the driver. Once the brake signal is activated, the brake light subsystem is activated. This subsystem will initiate the flow of electrical current to sequentially illuminate a set number of LED arrays corresponding to the area on the taillight designated for the brake light. When the brake signal is deactivated, the LED arrays will sequentially turn off either in reverse sequential order of activation or in a different sequential pattern or order than they were illuminated.

The blinker signal is off until the blinker is activated by the driver. Once the blinker signal is activated, the blinker light subsystem is activated. This subsystem will sequentially initiate the flow of electrical current to illuminate a set number of LED arrays corresponding to the area on the taillight designated for the blinker light. The arrays designated for the blinker will sequentially illuminate as well as sequentially turn off with every pulse of the blinker signal. While turning off, the LED arrays will sequentially turn off, not necessarily in the same pattern or order in which they were turned on.

Depending on the model of the automobile, the rear markers are handled somewhat differently. When the rear markers are activated, the LED arrays will be partially illuminated. These arrays may or may not be the same arrays used as the brake light. In the case that these arrays are the same arrays used in the brake light, when the brake system is activated, these arrays will sequentially illuminate from partial brightness to full brightness.

Most current “Euro” style lights on the market are comprised of three main parts: the main enclosure, the outer lens, and the inner lens(es). One side of the main enclosure is designed to be mounted to the automobile and the other side is designed to direct the incandescent light, house the bulbs, inner, and outer lenses, while still remaining visually sleek. The display side of the main enclosure is then coated with a chrome finish to add the necessary reflective properties to focus the light. The outer lens is made of clear plastic and is designed to fit the main enclosure such that it can be easily sealed to make the enclosure waterproof. The inner lens(es) are either clear, red, or orange, and act to both color the emitted light and act as a reflector.

The subject invention adds two or three parts to this design, the LEDs, the PCB and associated circuitry, and the insert which adapts the PCB and LEDs to the main enclosure. The LEDs are selected and arranged in such a way as to meet all DOT and SAE regulations on light intensity, emitted wavelength, and viewing angles. All of the circuitry and LEDs are mounted in a main housing that easily attaches to a modified taillight housing. The circuitry consists of resistors, capacitors, MOSFETS, and basic integrated circuits. All of these parts, along with the LEDs, are placed onto a printed circuit board which completes the electronic assembly. The LED arrangement on the circuit board will be determined by the style of the taillights in question (different cars have different styles of lighting). The electronic assembly will then be mounted into the main housing. The main housing is then affixed onto the modified taillight housing to produce a nice, neat, and professional self-contained, independent taillight unit. The OEM incandescent bulb plug will be able to also power the newly modified taillight by way of a special plug on the back of the main light housing.

Once the entire assembly is complete and functional, the LEDs serve as the main brake and turn signal lighting, just as an incandescent bulb would. However, when, for example, the brake is applied, the LEDs will all power on and then all power off in a sequential or patterned manner, to provide a most interesting look, while still meeting or exceeding all safety regulations and requirements.

Thus, the subject system employs the visual uniqueness of the “Euro” taillight, while incorporating the use of LEDs to create an even more visually appealing and safe product. LEDs are superior to traditional incandescent bulbs in that they respond quicker, last longer, and operate at cooler temperatures. Furthermore, due to their smaller size and power consumption properties, they can be implemented in arrays and activated individually. The present invention represents the first replacement taillight assembly to utilize LED technology to take advantage of these characteristics, and provide a sequential illumination of LED arrays.

The novel features which are considered as characteristic of the invention are set forth in particular in the appended claims. The panel display system itself, however, both as to its design, construction, and use, together with additional features and advantages thereof, are best understood upon review of the following detailed description with reference to the accompanying drawings.

### BRIEF DESCRIPTION OF THE DRAWINGS

FIG. 1 is a front view of a taillight incorporating the system of the present invention.

FIG. 2 is a perspective view of taillight incorporating the system of the present invention.

FIG. 3 is a side view of a taillight lighting element of the present invention.

FIG. 4 is a side view of a main taillight enclosure of a taillight incorporating the system of the present invention.

FIG. 5 is a diagrammatic representation showing the sequential timing of LED illumination and deactivation in reverse order.

FIG. 6 is an alternate, diagrammatic representation showing the sequential timing of LED illumination and deactivation in reverse order.

FIGS. 7a-7h show a sequential illumination and deactivation of a brake light of a taillight incorporating the system of the present invention.

FIGS. 8a-8l show a sequential illumination and deactivation of a blinker of a taillight incorporating the system of the present invention.

FIG. 9 is a schematic representation showing the generic controller circuit of the system of the present invention.

FIG. 10 is a schematic representation showing three input signals employed in a generic controller circuit of the system of the present invention.

FIG. 11 is a schematic representation of the analog controller circuit employed in the system of the present invention.

FIG. 12 shows a schematic representation of the digital controller circuit employed in the system of the present invention.

FIG. 13 is a schematic representation of the microprocessor controller circuit employed in the system of the present invention.

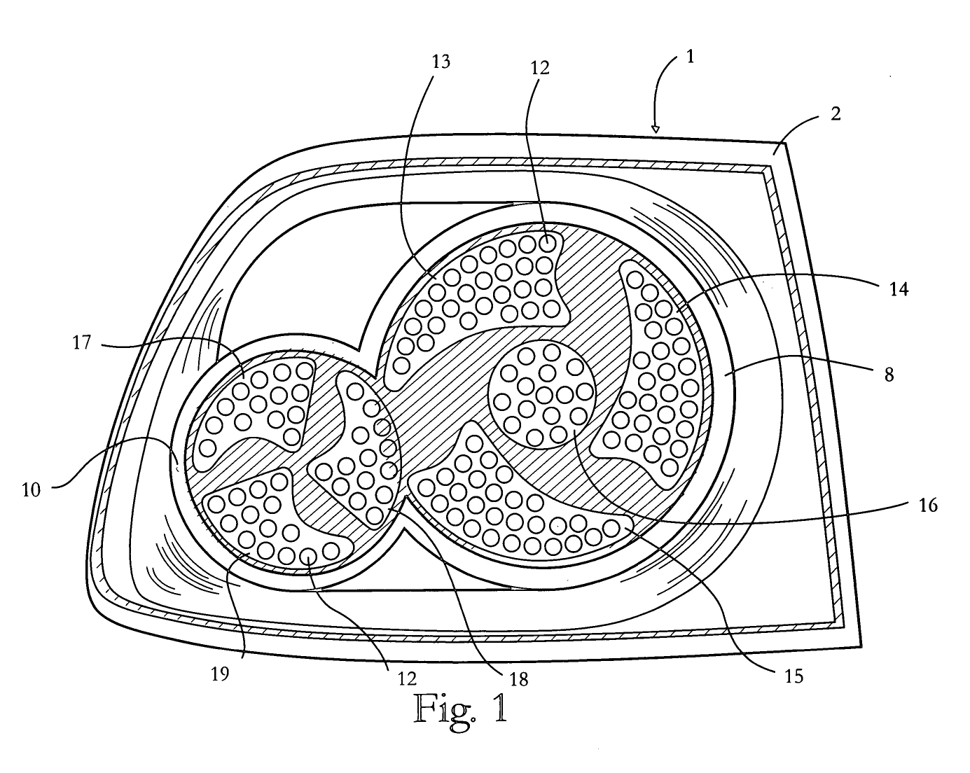

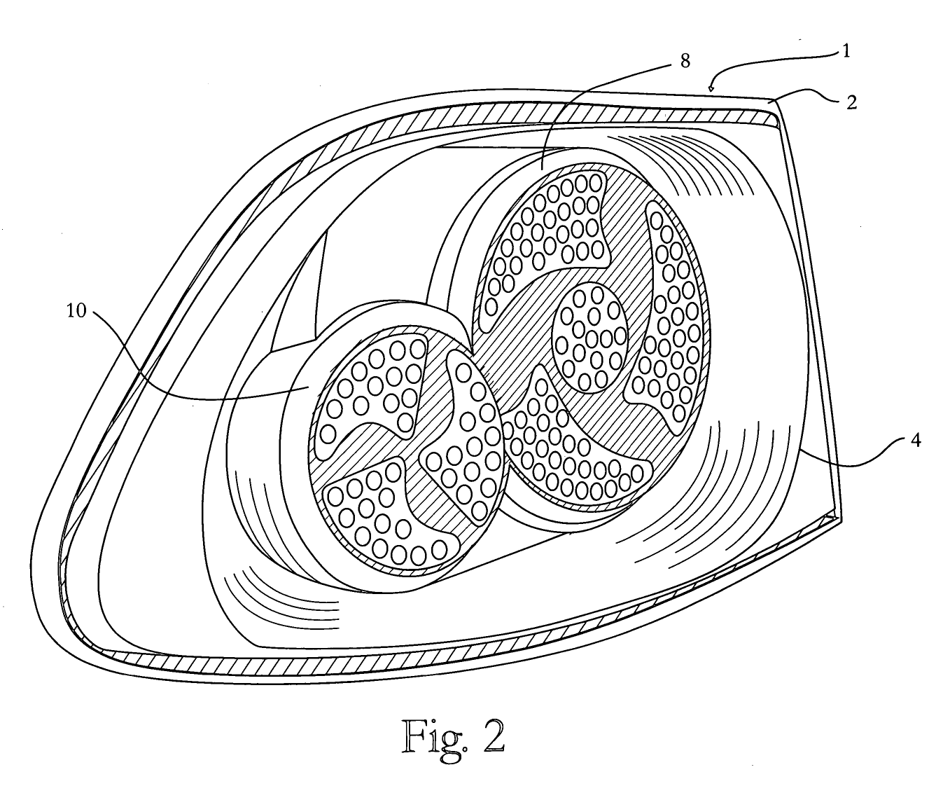

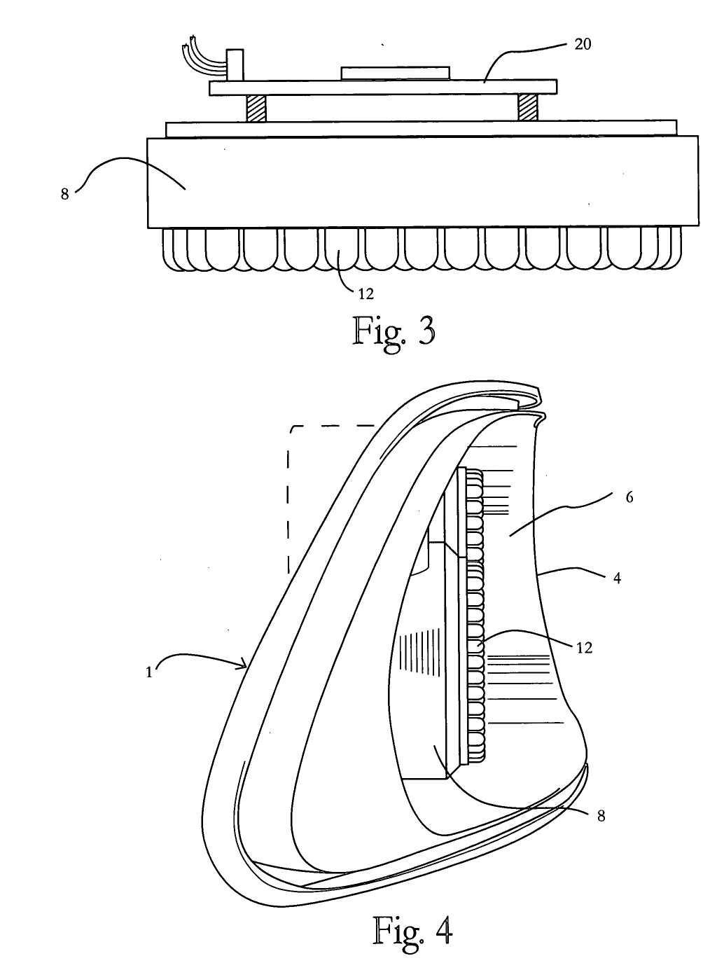

### DETAILED DESCRIPTION OF THE INVENTION

Taillight 1 comprises main taillight enclosure 2 with outer lens 4 enclosing space 6 in which LED brake section housing 8 and turn signal blinker section 10 are located. Housing 8 contains the circuitry and LEDs 12, within LED arrays 13, 14, 15, and 16, for sequentially illuminating the brake light and rear marker system. Housing 10 contains the circuitry and LEDs 12, with LED arrays 17, 18 and 19, for sequentially illuminating the turn signal blinker system. Suitable vehicle mount 20 is provided for attaching taillight 1 to the vehicle.

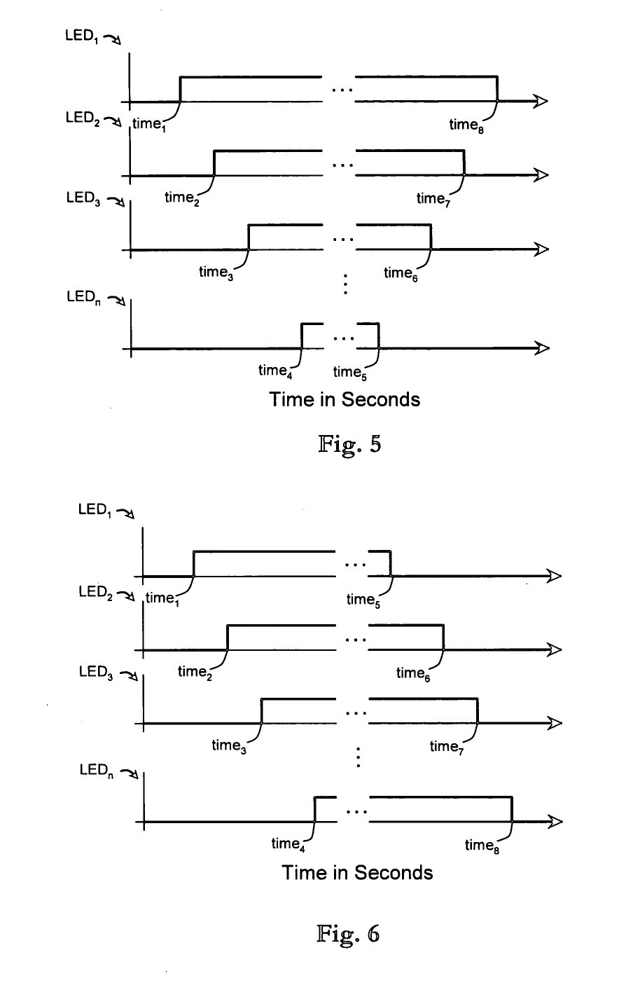

FIGS. 5 and 6 show a graphic representation of the timing of the system of the invention. In FIG. 5, the brakes of a motor vehicle are applied at time1, causing LED1 to turn on. LED2 through LEDn sequentially turn on at time2 through time4 respectively. At time5, the brakes would no longer be applied causing LEDn to turn off. LEDn-1 through LED1 would then sequentially turn off. This pattern would typically be used for a brake light. It is noted that for the design to be functional, the time between time1 and time4 must be less then the amount of time for a incandescent bulb to reach full brightness. This also applies for the time between time5 and time8.

A similar sequence of operation is shown in FIG. 6, which is more indicative of the sequential pattern for the turn signal blinker operation. However, both of these patterns could be used for the blinker system.

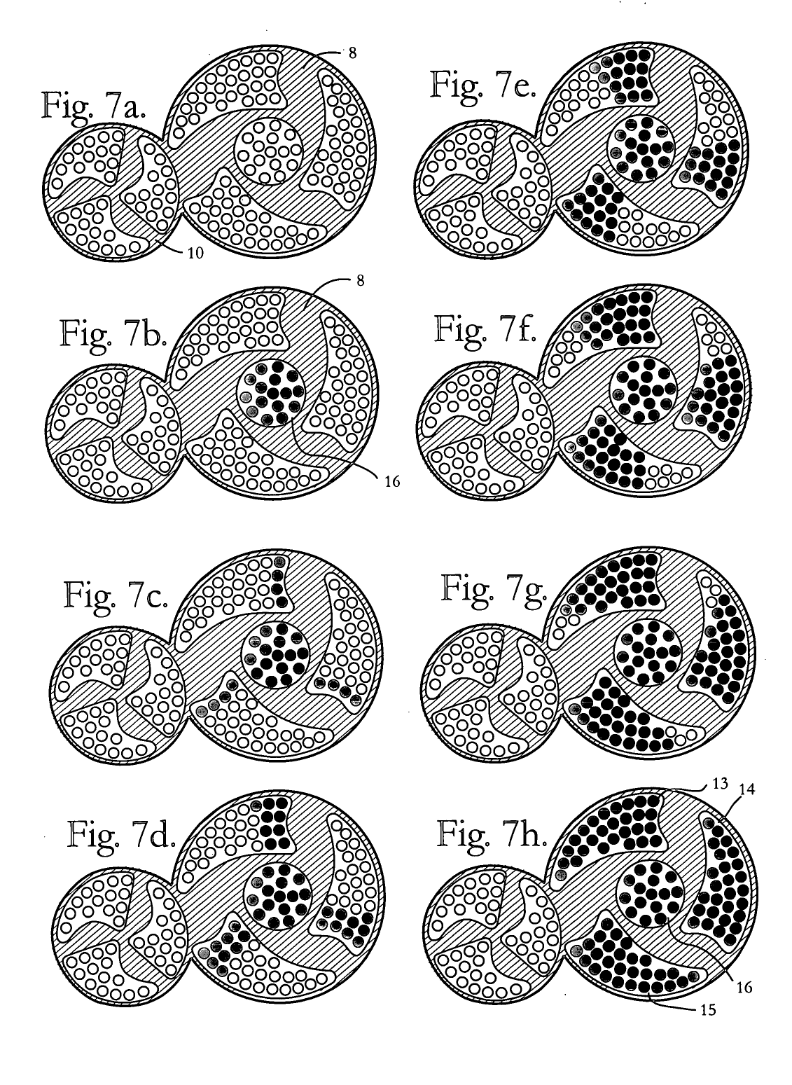

FIGS. 7a-7h shows the sequence of illumination of typical motor vehicle brake lighting of the system of the invention. FIG. 7a shows a rear view of the taillight array of the invention before the brake is applied. Sequential illumination begins, as shown in FIG. 7b, when the brake signal is sent, i.e. the driver steps on the brake. Electrical current flows to the taillight and LED array 16 of taillight brake section 8 lights up initially. FIGS. 7c-7g show the continuing sequence of illumination of the other LED arrays, with FIG. 7h showing all brake section arrays 13-16 fully illuminated. Significantly, this invention is not restricted to the illumination sequence described in FIGS. 7a-7h. Any desired sequence of illumination and then deactivation of the LED arrays of section 8 can be programmed into the system.

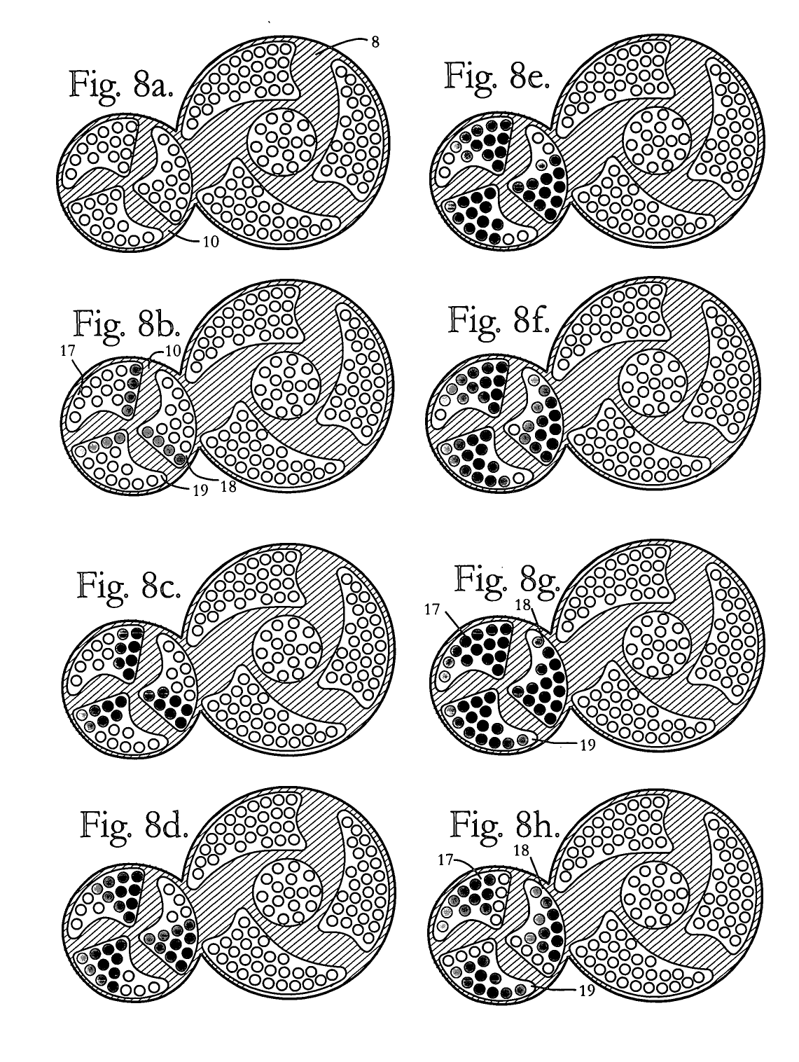

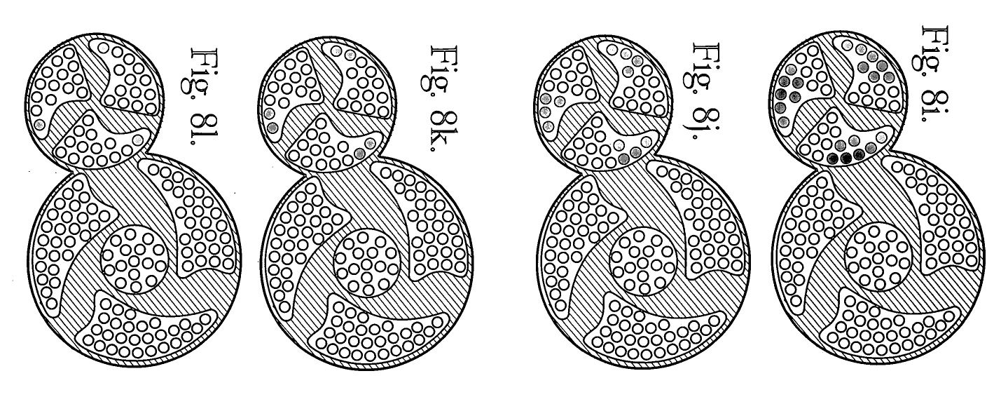

Similarly, FIGS. 8a-8l show the sequence of illumination of typical motor vehicle turn signal blinker lights of the system of the invention. FIG. 8a shows a rear view of the taillight arrays before the blinker is set. Sequential illumination begins, as shown in 8b, when the blinker signal is sent, i.e. when the blinker is put on. Electrical current flows to the taillight and sections of LED arrays 17, 18, and 19 of blinker section 10 light up initially. FIGS. 8c-8f show the continuing sequence of illumination of the other LED arrays, with FIG. 8g showing all blinker section arrays 17-19 fully lit. Sequential deactivation begins with selected LEDs in arrays 17, 18, and 19 turning off as seen in FIG. 8h, and deactivation continues, as show in FIGS. 8i-8l. If the blinker remains on and, hence the blinker signal is still being received, the sequential illumination cycle begins again. Sequential blinker illumination ceases when the blinker is off and no signal is being sent. Once again, the invention is not restricted to the illumination and deactivation sequence described in FIGS. 8a-8l. Any desired sequence of illumination and then deactivation of the LED arrays of section 10 can be programmed into the system.

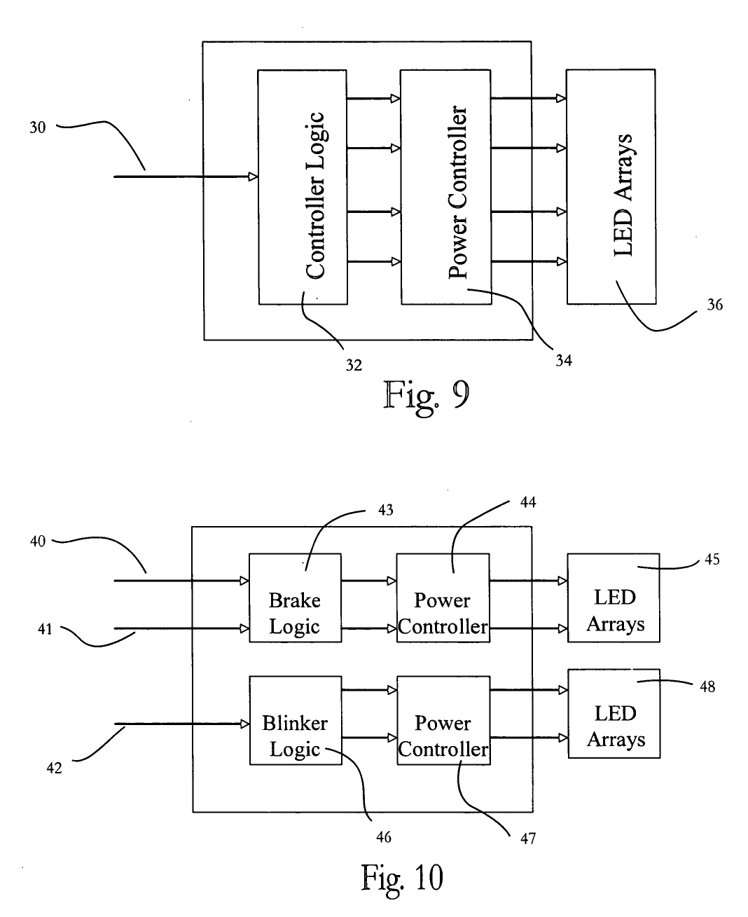

FIG. 9 is a schematic representation of the operation of the generic controller circuit of the invention. Input signal 30, be it the signal received from the application of the brake, the turn signal blinker system, or the rear marker, is transmitted to controller logic component 32 which in turn transmits a control signal, through power controller 34, comprising electrical transistors, e.g. MOSFETS, which serve to sequentially illuminate LED arrays 36.

FIG. 10 is a schematic representation of the operation of the generic controller circuit, showing the control paths of brake signal 40, rear marker signal 41, and turn signal blinker system 42. Brake signal 40 and rear marker signal 41 are both transmitted to brake logic controller 43 and blinker signal 42 is sent through blinker logic controller 46. The brakes and rear marker control signals and blinker signals are transmitted to separate power controllers 44 and 47, respectively, to sequentially illuminate LED arrays 45 in taillight brake section 8 and 48 in blinker section 10.

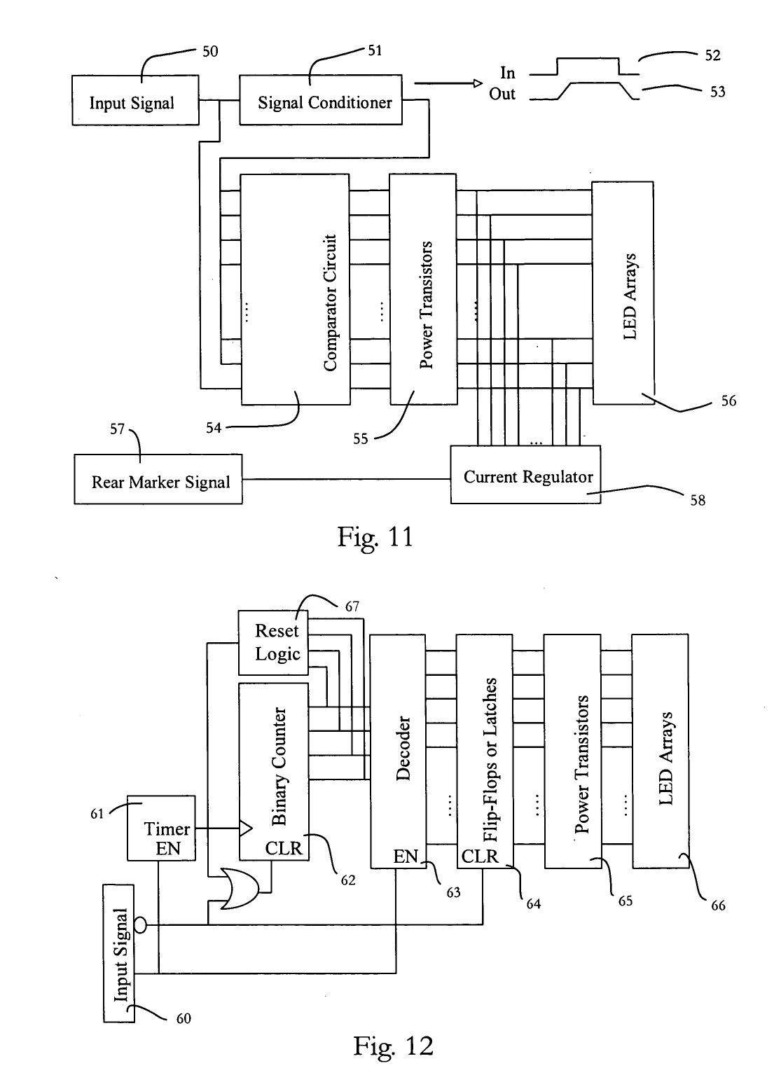

FIG. 11 is a schematic representation of an exemplar circuit which uses an analog controller. Input signal 50 coming from the brake or turn signal blinker is inherently a square wave pulse or pulses 52. This signal is reconditioned through signal condition 51 into signal 53 with a positive sloping signal at the positive signal edge and a negative sloping signal at the negative signal edge. Conditioned signal 53 is used as an input into comparator circuit 54. Comparator circuit 54 consists of ‘x’ number of comparators based on the number of LED arrays in the sequential light. Each comparator will compare the input signal to a predefined value. If the signal is greater than this value, the comparator will trigger a power transistor 55 dedicated to an LED array 56 and illuminate the array. Every comparator's predefined value is greater than the previous comparator. Since the conditioned input signal has a positive sloping edge, each comparator triggers its respective power transistor sequentially, therefore illuminating each LED array in succession. When the input signal is deactivated, the reconditioned signal becomes a negative sloping edge which extinguishes the LED arrays in the reverse order they were illuminated. In the case where the rear marker uses the same LED arrays as the designated brake light, when rear marker signal 57 is activated, current regulator 58 is used to illuminate these LED arrays at partial brightness. A brake signal input will then cause the LED arrays to be illuminated sequentially to full brightness.

FIG. 12 is a schematic representation of an exemplar circuit employing a digital controller which uses several elementary digital components to implement the taillight controller. When input signal 60 goes high it enables clock or timer 61 which causes binary counter 62 to begin counting. Decoder 63 is used to convert the binary output of counter 62 into a discrete output on the node corresponding to the binary code. That is, if the binary output of the counter is four then the fourth output of the decoder would be high and all other outputs would be low. All of the outputs of decoder 63 are then fed into a latching system 64, allowing the state of the latching system to change whenever the corresponding decoder output is high. The outputs of the latches are then connected to power transistors 65 which control their corresponding LED arrays 66. The counter increments its count on every clock cycle until it reaches the reset criteria. At that point the counter either resets to zero or begins counting down. This allows the circuit to count through and turn on the LED arrays sequentially from the first array to the last array. In the case where reset function 67 sets the counter back to zero, the circuit will sequentially turn off the LED arrays from the first array to the last array. In the case where the reset function causes the counter to count down, the circuit will sequentially turn off the LED arrays from the last array to the first array. Furthermore, the reset function can also be used to stop the clock, which would be necessary for the implementation of the brake light. In this way, after the LED arrays are all on, the circuit will stop and wait for the input to go low. At that point, the circuit will allow the timer to restart until the turn off sequence is completed.

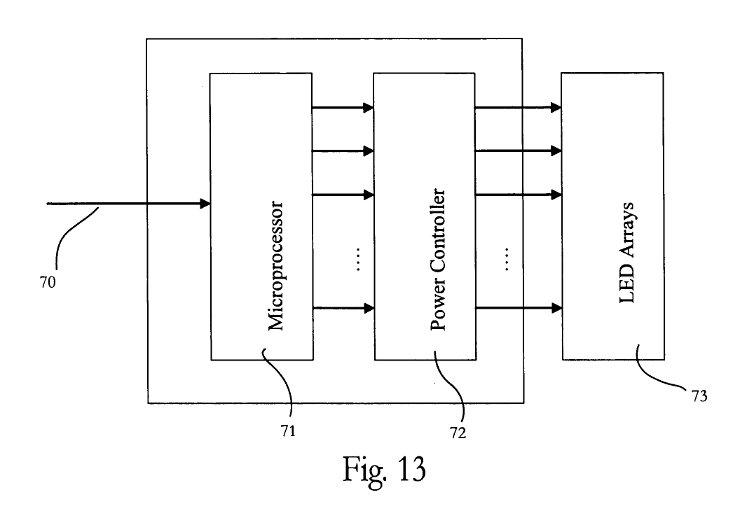

FIG. 13 is a schematic representation of an exemplar controller circuit which uses a microprocessor. In this system the input signals 70, such as brake signal, blinker signals, and rear marker signals, are fed into microprocessor 71. The microprocessor is programmed to trigger individual outputs based on a function of the inputs. These outputs are triggered sequentially based on the input signals. The microprocessor outputs are used to activate individual power transistors 72, powering LED arrays 73. This will allow any sequential illumination of LED arrays. The programmable feature of the microprocessor design will allow different illumination and deactivating sequences.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A motor vehicle taillight system for the sequential illumination of light emitting diodes (LEDs) comprising:
a motor vehicle taillight element;
input means for providing a signal to the taillight element;
a series of LEDs forming an LED array; and
activating means for providing a flow of electrical current to sequentially illuminate the LEDs in the LED array upon receipt of the signal from the input means and to cease the flow of electrical current to sequentially deactivate the LED array upon cessation of the signal from the input means.

2. The motor vehicle taillight system as in claim 1 whereby the activating means comprises system controller means for sequentially illuminating and deactivating the LEDs in the LED array.

3. The motor vehicle taillight system as in claim 1 whereby the activating means comprises system controller means for sequentially illuminating and deactivating the LEDs in the LED array corresponding to a brake light area on the taillight element.

4. The motor vehicle taillight system as in claim 1 wherein the LEDs in the LED array are deactivated in the reverse sequential order as they were sequentially illuminated.

5. The motor vehicle taillight system as in claim 1 wherein the LEDs in the LED array are deactivated in a different sequential order than they were illuminated.

6. The motor vehicle taillight system as in claim 3 wherein the LEDs in the LED array are deactivated in the reverse sequential order as they were sequentially illuminated.

7. The motor vehicle taillight system as in claim 3 wherein the LEDs in the LED array are deactivated in a different sequential order than they were illuminated.

8. The motor vehicle taillight system as in claim 1 wherein the activating means comprises system controller means for sequentially illuminating and deactivating the LEDs in the LED array corresponding to the a signal blinker area on the taillight element.

9. The motor vehicle taillight system as in claim 8 wherein the LEDs in the LED array are deactivated in the same reverse sequential order as they were sequentially illuminated.

10. The motor vehicle taillight system as in claim 1 wherein the activating means comprises system controller means for sequentially illuminating and deactivating the LEDs in the LED array corresponding to a rear marker area on the taillight element.

11. The motor vehicle taillight system as in claim 10 wherein the LEDs in the LED array are sequentially deactivated in the same order as they were sequentially illuminated.

12. The motor vehicle taillight system as in claim 3 whereby the system controller means also illuminates and deactivates the LEDs in the LED array corresponding to the brake light area when the activating means receives a signal indicating the vehicle is traveling in reverse.

13. The motor vehicle taillight system as in claim 2 wherein the activating means further comprises power controller means connected downstream of the system controller means to control electrical current flow to the LED array.

14. The motor vehicle taillight system as in claim 13 wherein the power controller means comprises transistors.

15. The motor vehicle taillight system as in claim 13 wherein the power controller means comprises a metal-oxide semi-conductor field effect transistor (MOSFET).

16. The motor vehicle taillight system as in claim 1 wherein the series of LEDs form a plurality of LED arrays.

17. The motor vehicle taillight system as in claim 3 wherein the brake light area comprises a plurality of LED arrays formed from the series of LEDs.

18. The motor vehicle taillight system as in claim 17 wherein the LED arrays in the brake light area sequentially illuminate and deactivate.

19. The motor vehicle taillight system as in claim 8 wherein the turn signal blinker light area comprises a plurality of LED arrays formed from the series of LEDs.

20. The motor vehicle taillight system as in claim 19 wherein the LED arrays in the turn signal light area sequentially illuminate and deactivate.

21. The motor vehicle taillight system as in claim 3 wherein the system controller means also sequentially illuminates and deactivates the LEDs in the LED array corresponding to a turn signal blinker area of the taillight element.

22. The motor vehicle taillight system as in claim 3 wherein the system controller means also sequentially illuminates and deactivates the LEDs in the LED array corresponding to a rear marker area of the taillight element.

23. The motor vehicle taillight system as in claim 21 wherein the system controller means also sequentially illuminates and deactivates the LEDs in the LED array corresponding to a rear marker area of the taillight element.

24. The motor vehicle taillight system as in claim 1 wherein the activating means comprises a microprocessor controller system.

25. The motor vehicle taillight system as in claim 1 wherein the activating means comprises a digital controller system.

26. The motor vehicle taillight system as in claim 1 wherein the activating means comprises an analog controller system.

27. A motor vehicle taillight system for the sequential illumination of light emitting diodes (LEDs), said taillight system having a taillight element comprising:
a series of LEDs forming a plurality of LED brake light arrays;
first input means for providing a signal to the brake light arrays;
a series of LEDs forming a plurality of LED turn signal blinker light arrays;
second input means for providing a signal to the blinker light arrays; and
activating means for providing a flow of electric current to sequentially illuminate the LEDs in the brake light LED arrays upon receipt of the signal from the first input means and to cease the flow of electric current to sequentially deactivate these LEDs upon cessation of the signal from the first input means, said activating means also providing a flow of electrical current to sequentially illuminate the LEDs in the turn signal blinker LED arrays upon receipt of the signal from the second input means and to cease the flow of electric current to sequentially deactivate these LEDs upon cessation of the signal from the second input means.

28. The motor vehicle taillight system as in claim 27 whereby the activating means comprises system controller means for sequentially illuminating and deactivating the LEDs in the LED arrays.

29. The motor vehicle taillight system as in claim 27 wherein the LEDs in the LED arrays are deactivated in the reverse sequential order as they were sequentially illuminated.

30. The motor vehicle taillight system as in claim 27 wherein the LEDs in the LED array are deactivated in a different sequential order tan they were illuminated.

31. The motor vehicle taillight system as in claim 27 further comprising a series of LEDs forming a rear marker array and third input means for providing a signal to these arrays.

32. The motor vehicle taillight system as in claim 27 wherein LEDs of the brake light arrays form rear marker indicators in the taillight element.

33. The motor vehicle taillight system as in claim 28 wherein the activating means further comprises power controller means connected downstream of the system controller means to control electrical flow to the LED arrays.

34. The motor vehicle taillight system as in claim 33 wherein the power controller means comprises transistors.

35. The motor vehicle taillight system as in claim 28 wherein the power controller means comprises a metal-oxide semi-conductor field effect transistor (MOSFET).

36. The motor vehicle taillight system as in claim 27 wherein the brake light LED arrays sequentially illuminate and deactivate.

37. The motor vehicle taillight system as in claim 27 wherein the turn signal blinker LED arrays sequentially illuminate and deactivate.

38. The motor vehicle taillight system as in claim 27 wherein the activating means comprises a microprocessor controller system.

39. The motor vehicle taillight system as in claim 27 wherein the activating means comprises a digital controller system.

40. The motor vehicle taillight system as in claim 27 wherein the activating means comprises an analog controller system.
